(19) United States
(12) Patent Application Publication
(10) Pub. No.: US 2013/0312883 A1
(43) Pub. Date: Nov. 28, 2013

(54) TIRE

(71) Applicant: KENDA RUBBER IND. CO., LTD., Changhua County (TW)

(72) Inventors: YING-MING YANG, Changhua County (TW); CHIEN-HSIN YANG, Changhua County (TW); TSUNG-YUEH LAI, Changhua County (TW); CHIH- HSIN LAI, Changhua County (TW)

(73) Assignee: KENDA RUBBER IND. CO., LTD., Changhua County (TW)

(21) Appl. No.: 13/677,722

(22) Filed: Nov. 15, 2012

(30) Foreign Application Priority Data
May 23, 2012 (TW) 101118379

(51) Int. Cl. B60C 19/12

(52) U.S. Cl. CPC B60C 19/12
USPC 152/187

(57) ABSTRACT

A tire includes a carcass and a tread member. The carcass has a tread portion, two sidewalls on opposite sides of the tread portion, and two beads on distal ends of the sidewalls. The tread member has a tread protective layer provided on an outer side of the tread portion of the carcass and a skin layer provided on the tread protective layer. In an embodiment the tire further includes a sidewall protective layer and a bead protective layer to protect the sidewalls and the beads of the carcass. The tire may have a good airtight condition and a light weight.

The current application claims a foreign priority to the patent application of Taiwan No. 101118379 filed on May 23, 2012.

### BACKGROUND OF THE INVENTION

1. Field of the Invention

The present invention relates generally to a tire, and more particularly to a tire, which is light-weight, puncture proof, and airtight.

2. Description of the Related Art

In conventional tires, they are coated with a coating on an inner side hereof to keep the tire pressure. However, sometime the coating is broken because the coating is coated unevenly or is deteriorated by temperature, or the tire is punctured or cut.

An earlier invention of the present inventor, which is published as Taiwan utility model patent M383501, taught a bicycle tire which provides two protective layers to replace the coating. The first protective layer is on a tread portion and sidewalls of the tire, and the second protective layer is on beads of the tire. A combination of the first and the second protective layers may avoid the loss of tire pressure. Each protective layer has reinforced powder to provide high puncture proof, cut proof, and wear proof. The invention further taught a rubber tread member, which is in contact with road, on the first protective layer to protect the first protective layer.

And now, we improve our earlier invention to provide a new tire with good puncture proof and airtight.

### SUMMARY OF THE INVENTION

The primary objective of the present invention is to provide a tire, which is light-weight, puncture proof, and airtight.

According to the objective of the present invention, a tire includes a carcass and a tread member. The carcass has a tread portion, two sidewalls on opposite sides of the tread portion, and two beads on distal ends of the sidewalls. The tread member has a tread protective layer provided on an outer side of the tread portion of the carcass and a skin layer provided on the tread protective layer.

Therefore, the tire of the present invention has a good airtight condition and a light weight.

### BRIEF DESCRIPTION OF THE DRAWINGS

FIG. 1 is a sectional view of a first preferred embodiment of the present invention;

FIG. 2 is a sectional view of a second preferred embodiment of the present invention;

FIG. 3 is a sectional view of a third preferred embodiment of the present invention; and

FIG. 4 is a sectional view of a fourth preferred embodiment of the present invention.

### DETAILED DESCRIPTION OF THE INVENTION

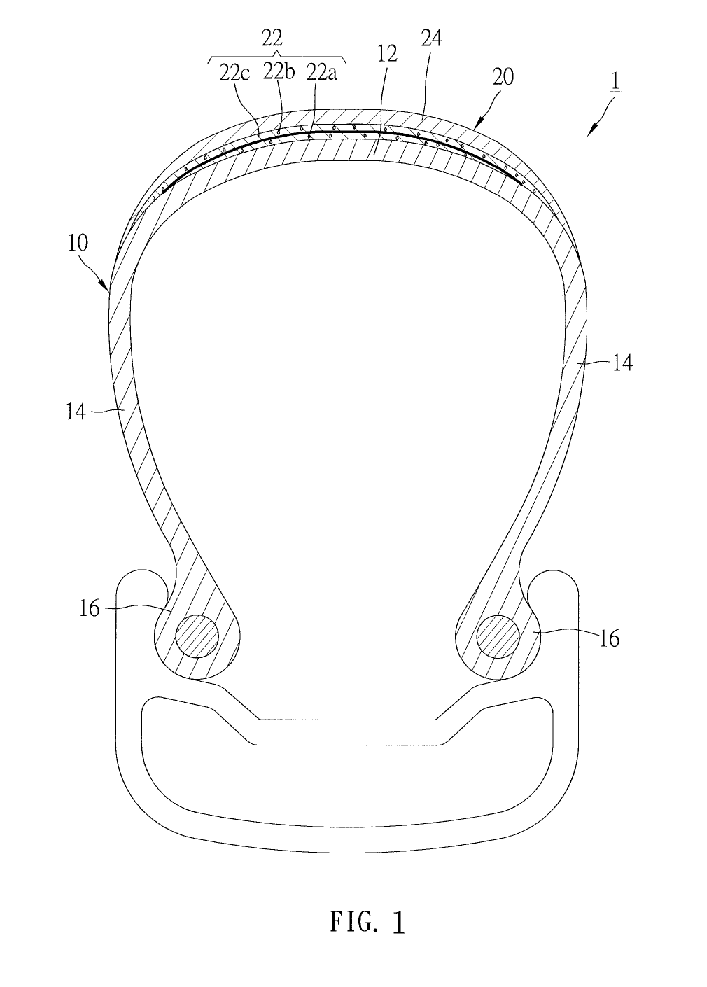

As shown in FIG. 1, a tire 1 of the first preferred embodiment of the present invention includes a carcass 10 and a tread member 20.

The carcass 10 is the main frame of the tire 1 which includes a tread portion 12, two sidewalls 14 on opposite sides of the tread portion 12, and two beads 16 respectively on distal ends of the sidewalls 14. The tread portion 12 will be deformed by pressure on the tire. In the present embodiment, the carcass is made of Kevlar yarns and rubber composite material, and a density of the Kevlar yarns is between 60 yarns per square inches and 300 yarns per square inches.

The tread member 20 is attached on an outer side of the tread portion 12 of the carcass 10, and includes a tread protective layer 22 and a skin layer 24.

The tread protective layer 22 is made of a composite material, including a carrier 22a, reinforced powder 22b, and rubber 22c. The tread protective layer 22 is attached to an outer side of the tread portion 12. The carrier 22a is an interlacing member and is inflexible to provide the tread member 20 a strong structure. In the present embodiment, the carrier 22a is made of interwoven bullet-proof yarns, and an interweaving density of which is between 30×30 yarns per square inches and 120×120 yarns per square inches. The bullet-proof yarns may be aromatic polyamide yarns (so called Kevlar yarns) or ultra high molecular weight polyethylene yarns (so called Dyneema yarns). A combination of the bullet-proof yarns and the rubber provides the tread protective layer 22 a high airtight performance. In practice, nylon and the equivalent material may be selected for the carrier 22a.

The reinforced powder 22b may be selected from bullet-proof ceramics powder, carbon fiber powder, hollow glass beads, glass fiber powder, or Kevlar powder. In the present embodiment, bullet-proof ceramics powder is selected. The reinforced powder 22b may increase the strength of the tread protective layer 22 to provide good puncture proof, cut proof, and wear proof.

The skin layer 24 is made of rubber, and is attached to an outer side of the tread protective layer 22. In the present embodiment, the skin layer 24 covers the entire tread protective layer 22. The skin layer 24 may choose rubber with various densities according to the function of the tire 1. Take off-road bicycle for example, low density rubber is selected for the skin layer 24 to provide the tire a high traction, and the tire for on-road bicycle is preferred a skin layer made of high density rubber.

In the tire 1 of the first preferred embodiment, the tread member 20 is provided on the tread portion 12 of the carcass 10 where the tire 1 has the greatest deformation and the highest risk to be punctured. The tread protective layer 22 of the tread member 20 may keep the tire pressure. The reinforced powder 22b of the tread protective layer 22 provides the tire 1 good puncture proof, cut proof, and wear proof. The tread protective layer 22 is covered by the skin layer 24 so that the tread protective layer 22 may be made thinner to reduce the weight of the tire 1.

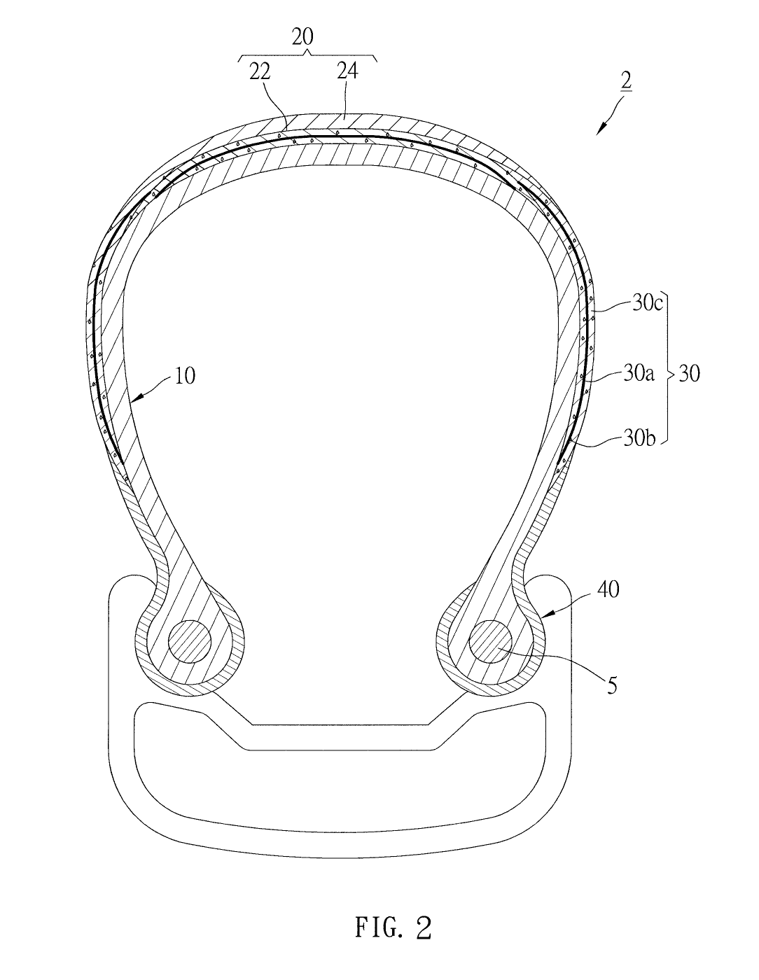

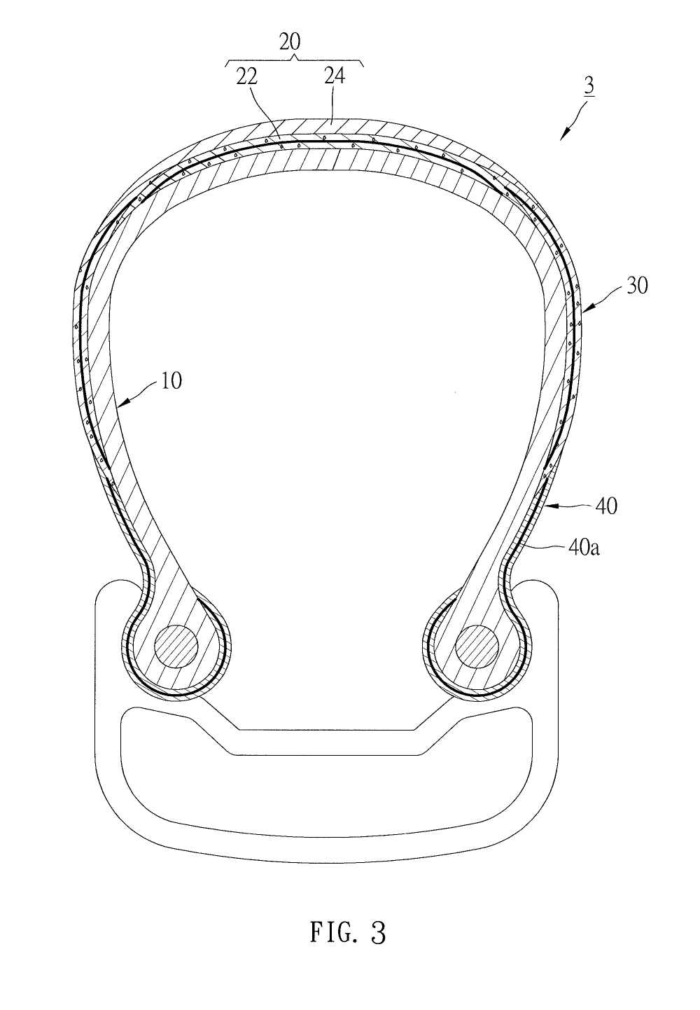

FIG. 2 shows a tire 2 of the second preferred embodiment of the present invention which further includes two sidewall protective layers 30 and two bead protective layers 40 respectively attached to the sidewalls and the beads of the carcass 10. Similar to the tread protective layer 22 of the tread member 20, the sidewall protective layers 30 are made of a composite material, including an interlacing carrier 30a, reinforced powder 30b, and rubber 30c to protect the sidewalls of the tire 2. The bead protective layers 40 mainly are made of rubber to protect the beads of the tire 2. FIG. 3 shows a tire 3 of the third preferred embodiment of the present invention in which each bead protective layer 40 is provided with an interlacing carrier 40a therein to enhance a wear resistance of a rim flange 5.

The tread protective layer 22, the sidewall protective layers 30, and the bead protective layers 40 as shown in FIG. 2 and FIG. 3 each has a portion overlapping each other for airtight purpose. The sidewall protective layers 30 and the bead protective layers 40 increase a little bit weight of the tire, however, the sidewalls and the beads may be thinner consequently, and therefore, the total weight of the tire still is reduced.

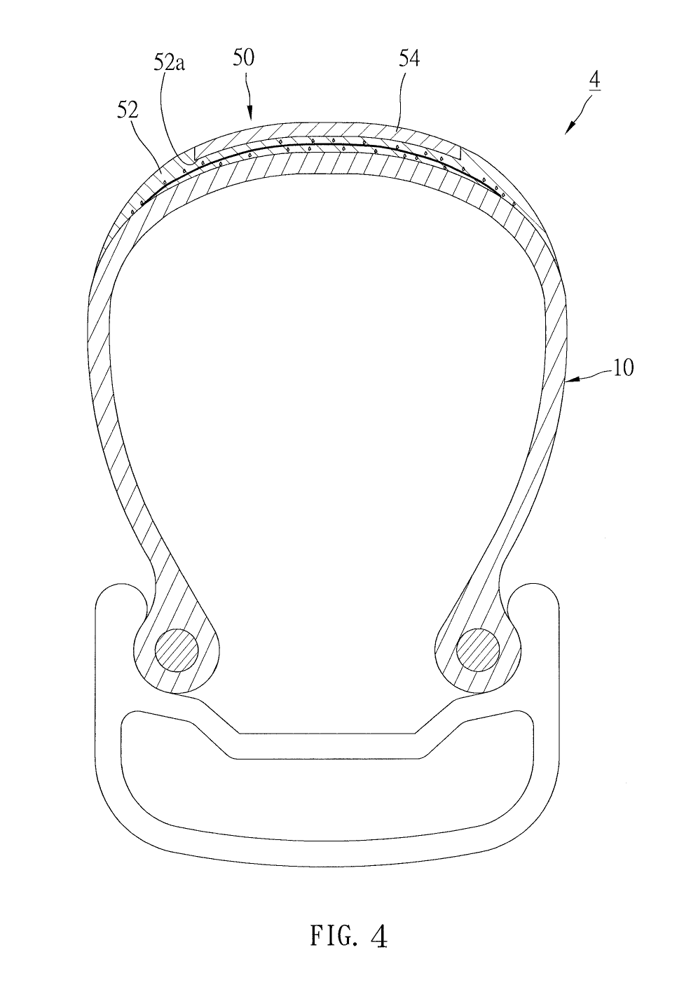

FIG. 4 shows a tire 4 of the fourth preferred embodiment of the present invention which has a tread member 50 with a tread protective layer 52 and a skin layer 54 as above. The different part is that the tread protective layer 52 has a slot 52a on an outer side thereof, and the skin layer 54 is a rubber block received and fixed in the slot 52a. In this embodiment, the skin layer 54 still is the part of the tire in contact with road. The tread protect layer 52 and the skin layer 54 are made of different materials so that the weight of the tire still is reduced by choosing a suitable combination of the tread protect layer 52 and the skin layer 54.

The description above is a few preferred embodiments of the present invention and the equivalence of the present invention is still in the scope of claim construction of the present invention.

What is claimed is:

1. A tire, comprising:
a carcass having a tread portion, two sidewalls on opposite sides of the tread portion, and two beads on distal ends of the sidewalls; and
a tread member having a tread protective layer provided on an outer side of the tread portion of the carcass and a skin layer provided on the tread protective layer.

2. The tire as defined in claim 1, wherein the tread protective layer is made of a composite material including a carrier, reinforced powder and rubber.

3. The tire as defined in claim 2, wherein the carrier is inflexible.

4. The tire as defined in claim 2, wherein the carrier is made of interwoven yarns, and an interweaving density thereof is between 30×30 yarns per square inches and 120×120 yarns per square inches.

5. The tire as defined in claim 4, wherein the yarns are bullet-proof yarns.

6. The tire as defined in claim 5, wherein the bullet-proof yarns are aromatic polyamide yarns or ultra high molecular weight polyethylene yarns.

7. The tire as defined in claim 4, wherein the yarns are made of nylon.

8. The tire as defined in claim 2, wherein the reinforced powder is selected from a group consisting of bullet-proof ceramics powder, carbon fiber powder, hollow glass beads, glass fiber powder, and Kevlar powder.

9. The tire as defined in claim 1, wherein the skin layer covers the entire tread protective layer.

10. The tire as defined in claim 1, wherein tread protective layer has a slot, and the skin layer is received in the slot.

11. The tire as defined in claim 1, further comprising two sidewall protective layers provided on the sidewalls of the carcass, wherein the sidewall protective layers are made of a composite material including a carrier, reinforced powder and rubber, and each of the sidewall protective layer has at least a portion overlapping the tread protective layer.

12. The tire as defined in claim 11, further comprising two bead protective layers provided on the beads of the carcass, wherein the bead protective layers are made of a composite material including rubber, and the bead protective layers respectively have at least a portion overlapping the sidewall protective layers.

13. The tire as defined in claim 12, wherein the bead protective layers has an interlacing carrier therein.
